(19) United States
(12) Patent Application Publication
(10) Pub. No.: US 2026/0273638 A1
(43) Pub. Date: Sep. 17, 2026

(54) CATHODE TOOL, METHOD AND SYSTEM FOR COUNTER-ROTATING ELECTROCHEMICAL MACHINING WITH INTERNAL FLUSHING

(71) Applicant: Nanjing University of Aeronautics and Astronautics, Nanjing City (CN)

(72) Inventors: Dengyong WANG, Nanjing City (CN); Huayong LE, Nanjing City (CN); Di ZHU, Nanjing City (CN)

(73) Assignee: Nanjing University of Aeronautics and Astronautics, Nanjing City (CN)

(21) Appl. No.: 19/456,696

(22) Filed: Jan. 22, 2026

(30) Foreign Application Priority Data
Mar. 17, 2025 (CN) 202510316185.5

(51) Int. Cl. B23H 3/04; B23H 3/10

(52) U.S. Cl. CPC B23H 3/04; B23H 3/10; B23H 2200/00; B23H 2400/10

(57) ABSTRACT

The cathode tool for counter-rotating electrochemical machining with internal flushing includes a cathode outer ring and a liquid supply assembly. The cathode outer ring has an annular wall. Windows corresponding to convex structures on a surface of an anode workpiece are formed on an outer peripheral surface of the annular wall. A liquid outlet structure is formed in an area corresponding to a non-convex region on the surface of the anode workpiece. A liquid outlet of the liquid supply assembly is formed in the annular wall. The liquid outlet faces the anode workpiece. The cathode outer ring can rotate relative to the liquid outlet. The liquid outlet extends in a direction parallel to an axial direction of the annular wall. The liquid supply assembly is configured to receive an electrolyte from the outside and supply the electrolyte to the liquid outlet structure through the liquid outlet.

### CROSS-REFERENCE TO RELATED APPLICATION

This patent application claims the benefit and priority of Chinese Patent Application No. 202510316185.5 filed with the China National Intellectual Property Administration on Mar. 17, 2025, the disclosure of which is incorporated by reference herein in its entirety as part of the present application.

### TECHNICAL FIELD

The present disclosure relates to the technical field of electrochemical machining, in particular to a cathode tool, method and system for counter-rotating electrochemical machining with internal flushing.

### BACKGROUND

A casing is an important bearing member of an aeroengine. Different shapes of mounting seats and reinforcing ribs are distributed on inner and outer walls of the casing. The casing is a large thin-walled rotating part with a complex surface. Most of casing materials are difficult-to-machine materials such as nickel-based superalloys or titanium alloys. Traditional machining methods have problems such as long machining cycle, high tool costs, and proneness to workpiece deformation. A wall thickness of chemical milling is poor in precision, and a corrosive liquid used is harmful to human bodies and the environment. Electrodes and processes during segmented electrochemical machining used in other countries are cumbersome. To solve this machining problem, some counter-rotating electrochemical machining methods are provided in related technologies. However, a workpiece anode and a tool cathode in a counter-rotating electrochemical machining method provided in the related technologies are completely immersed in an electrolyte in a flushing fixture, and an electrochemical anode dissolving reaction occurs in the flushing fixture, thereby inevitably generating the phenomenon of stray corrosion during machining. In addition, the electrolyte flows into a machining area from one side of the flushing fixture, and flows out from the other side. Because various convex structures on a workpiece surface affect flow field distribution of the machining area, it is difficult to control the electrolyte in the machining area, thereby affecting the machining stability.

### SUMMARY

An objective of the present disclosure is to provide a cathode tool, method and system for counter-rotating electrochemical machining with internal flushing, so as to solve the foregoing problems existing in the prior art and improve the machining stability.

In order to achieve the foregoing objective, the present disclosure provides the following solution.

The present disclosure provides a cathode tool for counter-rotating electrochemical machining with internal flushing, including:
a cathode outer ring, where the cathode outer ring has an annular wall, the annular wall is a conductor, windows corresponding to convex structures on a surface of an anode workpiece are formed on an outer peripheral surface of the annular wall, and a liquid outlet structure is formed in an area corresponding to a non-convex region on the surface of the anode workpiece; and
a liquid supply assembly, where a liquid outlet of the liquid supply assembly is formed in the annular wall, the liquid outlet faces the anode workpiece, in a machining state, the cathode outer ring is able to rotate relative to the liquid outlet, the liquid outlet extends in a direction parallel to an axial direction of the annular wall, a bottom of the liquid outlet along the axial direction of the annular wall is not higher than a bottom of the liquid outlet structure along the axial direction of the annular wall, a top of the liquid outlet along the axial direction of the annular wall is not lower than a top of the liquid outlet structure along the axial direction of the annular wall, and the liquid supply assembly is configured to receive electrolyte from an outside and supply the electrolyte to the liquid outlet structure through the liquid outlet.

In some embodiments, the liquid supply assembly includes a cathode inner ring, the cathode inner ring is of a hollow sleeve-like structure, the cathode inner ring is arranged inside the cathode outer ring, the liquid outlet is formed in a side of the cathode inner ring, a liquid inlet is formed in a bottom or a top of the cathode inner ring, the cathode inner ring and the cathode outer ring are arranged coaxially, and the cathode outer ring is rotatably arranged relative to the cathode inner ring.

In some embodiments, the cathode tool further includes a roller bracket, where the roller bracket is fixedly sleeved outside the annular wall, multiple circular arc grooves are formed in an outside of the roller bracket, the plurality of circular arc grooves are arranged parallel to an axis of the annular wall, sliding rollers are installed inside the plurality of circular arc grooves, and the cathode outer ring is sleeved outside the roller bracket and is in rolling contact with the sliding rollers.

In some embodiments, the liquid outlet structure is narrow slits or a group of holes formed in the annular wall.

In some embodiments, the cathode outer ring further includes a fixed plate coaxially and fixedly arranged at an end of the annular wall; an end face of an end of the cathode inner ring is in sliding contact or clearance fit with an inner wall of the fixed plate; the cathode inner ring further includes a first annular extension plate fixedly arranged at an end of the sleeve-like structure; and
the roller bracket is clamped and fastened on an outside of the cathode inner ring or is fixedly connected to the first annular extension plate through bolts.

In some embodiments, a liquid inlet tube is fixedly connected to the bottom of the cathode inner ring, an end of the liquid inlet tube is configured with a second annular extension plate extending radially outward, the second annular extension plate is installed inside the annular wall, an annular pressure plate is arranged on an outside of the second annular extension plate, and the annular pressure plate is fixedly connected to an end face of the annular wall and axially limits the second annular extension plate.

In some embodiments, annular sealing gaskets are clamped between the annular pressure plate and a side of the second annular extension plate, between an other side of the second annular extension plate and the end face of the cathode inner ring as well as an end face of the roller bracket, between a side of the first annular extension plate and an end face of the roller bracket, and between an other side of the first annular extension plate and the fixed plate.

In some embodiments, a guiding groove is arranged on the roller bracket in an area corresponding to the liquid outlet, two of the circular arc grooves are arranged on two sides of the guiding groove, and electrolyte limit rollers are arranged in the two of the circular arc grooves on the two sides of the guiding groove.

The present disclosure further provides a method for counter-rotating electrochemical machining with internal flushing, using the cathode tool for counter-rotating electrochemical machining with internal flushing as mentioned above, the method includes:
during electrolysis, driving the anode workpiece and the cathode outer ring to rotate in opposite directions at a same angular speed around their own axes, and simultaneously, driving the cathode tool for counter-rotating electrochemical machining with internal flushing to step or move continuously toward the anode workpiece.

The present disclosure further provides a system for counter-rotating electrochemical machining with internal flushing, including the cathode tool for counter-rotating electrochemical machining with internal flushing as mentioned above.

Compared with the prior art, the present disclosure achieves the following technical effects.

Firstly, in embodiments of the present disclosure, the cathode outer ring that can rotate separately is arranged, and the liquid outlet structure is formed in the cathode outer ring to flush a machining area. A dedicated flushing fixture does not need to be designed, thereby simplifying a machining process. In addition, the electrolyte is mainly controlled in the intermediate machining area, thereby significantly reducing stray corrosion in a non-machining area, and improving locality and molding accuracy of electrochemical machining.

Secondly, when a solution of the present disclosure is implemented, the flow rate of the electrolyte in the machining area is not affected by a machining depth and machining characteristics, and a flow field always remains stable, so that the present disclosure is applicable to electrochemical machining precision molding of various rotating components with complex convex structures.

### BRIEF DESCRIPTION OF THE DRAWINGS

To more clearly illustrate technical solutions in embodiments of the present disclosure or in the prior art, the following briefly introduces the drawings to be used in the embodiments. Apparently, the drawings in the following description show merely some embodiments of the present disclosure, and those skilled in the art can still derive other drawings from these drawings without creative efforts.

FIG. 1 is a half section view of a cathode tool for counter-rotating electrochemical machining with internal flushing during electrochemical machining according to an embodiment of the present disclosure.

FIG. 2 is a horizontal section view of a cathode tool for counter-rotating electrochemical machining with internal flushing during electrochemical machining according to an embodiment of the present disclosure.

FIG. 3 is a vertical section view of a cathode tool for counter-rotating electrochemical machining with internal flushing during electrochemical machining according to an embodiment of the present disclosure.

FIG. 4 is a structural schematic diagram of a roller bracket.

FIG. 5 is a structural schematic diagram of a cathode inner ring.

Reference numerals: 1 anode workpiece; 2 cathode outer ring; 3 cathode inner ring; 4 sealing gasket; 5 roller bracket; 6 narrow slit; 7 annular pressure plate; 8 liquid inlet tube; 9 sliding roller; 10 cathode window; 11 electrolyte limit roller 12 convex structure; 13 guiding groove; 14 circular arc groove; 15 first annular extension plate; 16 sleeve-like structure; and 17 liquid outlet.

### DETAILED DESCRIPTION OF THE EMBODIMENTS

The following clearly and completely describes technical solutions in embodiments of the present disclosure with reference to drawings in the embodiments of the present disclosure. Apparently, the described embodiments are merely a part rather than all of the embodiments of the present disclosure. All other embodiments obtained by those skilled in the art on the basis of the embodiments of the present disclosure without creative efforts fall within the scope of protection of the present disclosure.

To make the foregoing objective, features and advantages of the present disclosure clearer and more comprehensible, the present disclosure is further described in detail below with reference to the drawings and the specific implementations.

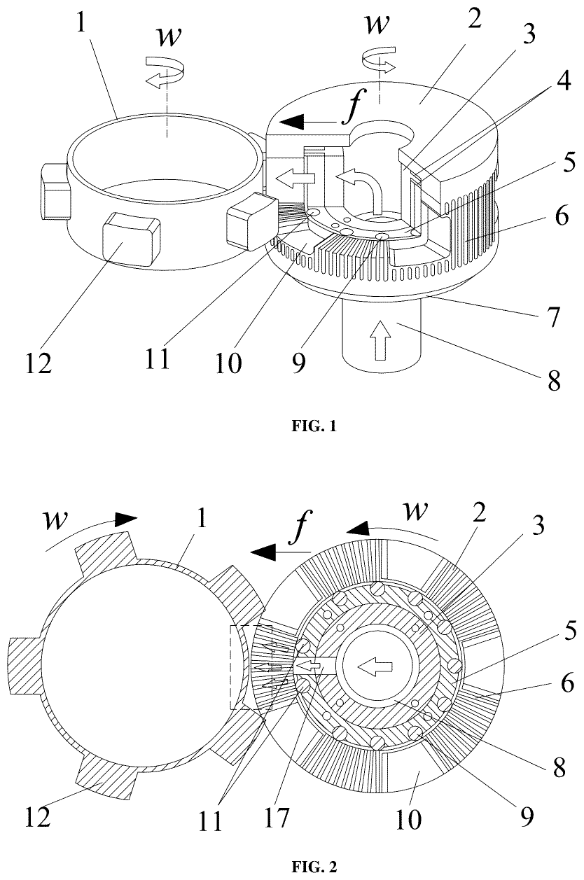

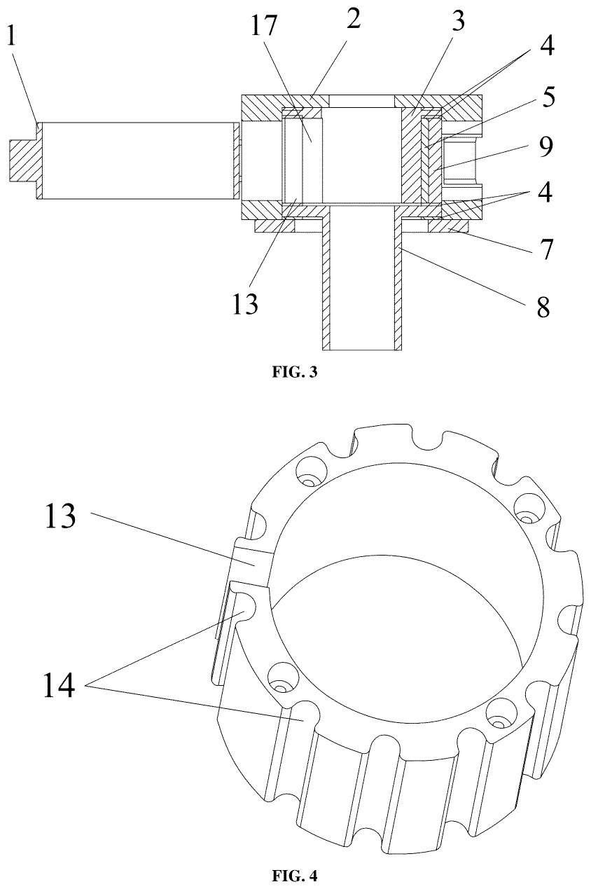

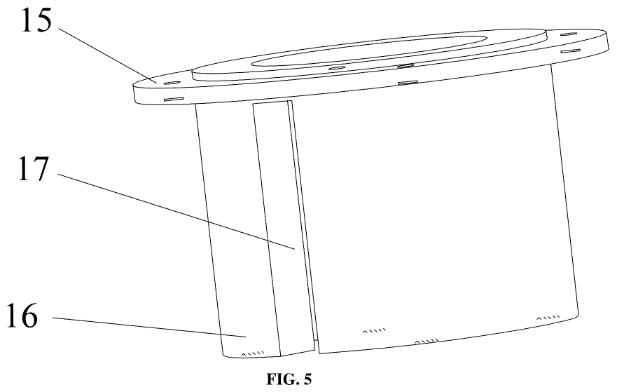

The following describes the embodiments of the present disclosure with reference to FIG. 1 to FIG. 5.

### Embodiment 1

The present disclosure provides a cathode tool for counter-rotating electrochemical machining with internal flushing, including a cathode outer ring 2 and a liquid supply assembly. The cathode outer ring 2 has an annular wall, the annular wall is a conductor. Windows corresponding to convex structures 12 on a surface of an anode workpiece 1 are arranged on an outer peripheral surface of the annular wall. A liquid outlet structure is arranged in an area corresponding to a non-convex region on the surface of the anode workpiece 1. A liquid outlet 17 of the liquid supply assembly is formed in the annular wall, the liquid outlet 17 faces the anode workpiece 1. In a machining state, the cathode outer ring 2 can rotate relative to the liquid outlet 17. The liquid outlet 17 extends in a direction parallel to an axial direction of the annular wall. A bottom of the liquid outlet 17 along the axial direction of the annular wall is not higher than a bottom of the liquid outlet structure along the axial direction of the annular wall. A top of the liquid outlet 17 along the axial direction of the annular wall is not lower than a top of the liquid outlet structure along the axial direction of the annular wall. The liquid supply assembly is configured to receive electrolyte from an outside and supply the electrolyte to the liquid outlet structure through the liquid outlet 17. In use, the liquid supply assembly does not rotate with the cathode outer ring 2 so that the direction of the liquid outlet is constant toward the anode workpiece 1.

In the present disclosure, the cathode outer ring 2 that can rotate separately is arranged, and the liquid outlet structure is formed in the cathode outer ring 2 to flush a machining area. A dedicated flushing fixture does not need to be designed, thereby simplifying a machining process. In addition, the electrolyte is mainly controlled in the intermediate machining area, thereby significantly reducing stray corrosion in a non-machining area, and improving locality and molding accuracy of electrochemical machining.

In addition, when a solution of the present disclosure is implemented, the cathode tool for counter-rotating electrochemical machining with internal flushing moves toward the anode workpiece 1 so as to keep a constant machining distance, and then the flow rate of the electrolyte in the machining area is not affected by a machining depth and machining characteristics, and a flow field always remains stable, so that the present disclosure is applicable to electrochemical machining precision molding of various rotating components with complex convex structures 12.

In some embodiments, the liquid supply assembly includes a cathode inner ring 3, the cathode inner ring 3 is of a hollow sleeve-like structure 16, the cathode inner ring 3 is arranged inside the cathode outer ring 2, the liquid outlet 17 is formed in a side of the cathode inner ring 3, a liquid inlet is formed in a bottom or a top of the cathode inner ring 3, the cathode inner ring 3 and the cathode outer ring 2 are arranged coaxially, and the cathode outer ring 2 is rotatably arranged relative to the cathode inner ring 3.

In use, the cathode inner ring 3 needs to keep still, so that the liquid outlet 17 on the side of the cathode inner ring 3 is always aligned with the anode workpiece 1, and only the cathode outer ring 2 is driven to rotate, so as to perform counter-rotating electrochemical machining.

In some embodiments, the present disclosure further includes a roller bracket 5. The roller bracket 5 is fixedly sleeved outside the annular wall, multiple circular arc grooves 14 are formed in an outside of the roller bracket 5, the circular arc grooves 14 are arranged parallel to an axis of the annular wall. Sliding rollers 9 are installed inside the circular arc grooves 14. The cathode outer ring 2 is sleeved outside the roller bracket 5 and is in rolling contact with the sliding rollers 9.

This embodiment implements that the cathode outer ring 2 is rotatably arranged relative to the cathode inner ring 3. Certainly, this embodiment is not limited thereto. In some embodiments, spherical grooves may be formed and balls are arranged in the spherical grooves so as to implement rotation of the cathode outer ring 2 relative to the cathode inner ring 3. For ease of understanding, an integral structure including the roller bracket 5, the cathode outer ring 2, and the balls or the sliding rollers 9 may be imagined as a bearing structure.

Certainly, in other embodiments, circular arc grooves 14 or the like may be directly formed on an outer wall surface of the cathode inner ring 3, thereby eliminating the need for the roller bracket 5.

In some embodiments, the liquid outlet structure is narrow slits 6 or a group of holes formed in the annular wall. That is, the group of holes includes multiple holes arranged in an array, and the narrow slits 6 are a relatively narrow opening extending in the direction parallel to the axis of the annular wall.

In some embodiments, the cathode outer ring 2 further includes a fixed plate coaxially and fixedly arranged at an end of the annular wall. An end face of an end of the cathode inner ring 3 is in sliding contact or clearance fit with an inner wall of the fixed plate. The cathode inner ring 3 further includes a first annular extension plate 15 fixedly arranged at an end of the sleeve-like structure 16. The roller bracket 5 is clamped and fastened on an outside of the cathode inner ring 3 or is fixedly connected to the first annular extension plate 15 through bolts.

This embodiment achieves objectives that the roller bracket 5 is fixed to the cathode inner ring 3 and the cathode outer ring 2 rotates independently.

In some embodiments, a liquid inlet tube 8 is fixedly connected to the bottom of the cathode inner ring 3. An end of the liquid inlet tube 8 is configured with a second annular extension plate extending radially outward. The second annular extension plate is installed inside the annular wall. The second annular extension plate is fixedly connected to the cathode inner ring 3 and/or the roller bracket 5. An annular pressure plate 7 is arranged on an outside of the second annular extension plate. The annular pressure plate 7 is fixedly connected to an end face of the annular wall and axially limits the second annular extension plate.

This embodiment may limit a rotational degree of freedom of the liquid inlet tube 8 so that the cathode inner ring 3 and the roller bracket 5 cannot rotate with rotation of the cathode outer ring 2.

In some embodiments, annular sealing gaskets 4 are clamped between the annular pressure plate 7 and a side of the second annular extension plate, between an other side of the second annular extension plate and the end face of the cathode inner ring 3 as well as an end face of the roller bracket 5, between a side of the first annular extension plate 15 and the other end face of the roller bracket 5, and between the other side of the first annular extension plate 15 and the fixed plate.

This embodiment enables the electrolyte in the cathode inner ring 3 to flow out only through the liquid outlet 17 and supply the electrolyte to the liquid outlet structure in a corresponding area of the cathode outer ring 2.

In some embodiments, a guiding groove 13 is arranged on the roller bracket 5 in an area corresponding to the liquid outlet 17, two of the circular arc grooves 14 are arranged on two sides of the guiding groove 13, and electrolyte limit rollers 11 are arranged in the two circular arc grooves 14 on both sides of the guiding groove 13.

This embodiment implements a limitation on an outflow area of the electrolyte. It may be understood that positions of the electrolyte limit rollers 11 are designed as required, that is, before the roller bracket 5 is manufactured, a drawing is designed as required and the positions of the circular arc grooves 14 are adjusted.

In this embodiment, various roller brackets 5 are arranged, and positions of the electrolyte limit rollers 11 of different roller brackets 5 are different, so that liquid outlet widths on various roller brackets 5 are different, thereby facilitating a user to replace different roller brackets 5 according to different machining requirements.

### Embodiment 2

The embodiment of the present disclosure provides a method for counter-rotating electrochemical machining with internal flushing. Performing electrochemical machining on the anode workpiece 1 by using the cathode tool for counter-rotating electrochemical machining with internal flushing in Embodiment 1. The method includes:
during electrolysis, driving the anode workpiece 1 and the cathode outer ring 2 to rotate in opposite directions at a same angular speed around their own axes, and simultaneously, driving the cathode tool for counter-rotating electrochemical machining with internal flushing to step or move continuously toward the anode workpiece 1.

Specifically, performing electrochemical machining on the anode workpiece 1 by using the cathode tool for counter-rotating electrochemical machining with internal flushing as mentioned above includes the following steps.

In step one, the anode workpiece 1 and the cathode outer ring 2 rotate relative to each other at a same angular speed, the cathode inner ring 3 keeps still, and the liquid outlet 17 on the cathode inner ring 3 and the guiding groove 13 on the roller bracket 5 always directly face the machining area of the workpiece anode.

In step two, the cathode outer ring 2, the cathode inner ring 3, and the electrolyte limit rollers 11 constitute a closed chamber for the electrolyte. After entering the cathode inner ring 3 from an electrolyte inlet, the electrolyte is restricted by the electrolyte limit rollers 11, and flows out from part of the narrow slits 6 of the cathode outer ring 2 which has been rotated to the area directly facing the guiding groove 13.

In step three, the anode workpiece 1 is connected to a positive electrode of a power supply, the cathode outer ring 2 is connected to a negative electrode of the power supply. While the cathode outer ring 2 and the anode workpiece 1 rotate opposite to each other, the cathode outer ring 2 is fed to the anode workpiece 1 at a constant speed with the cathode inner ring 3 and the roller bracket 5 inside the cathode outer ring 2, and the liquid inlet tube 8 outside the cathode outer ring 2.

In step four, part of materials of the anode workpiece 1 rotated to the liquid outlet structure are subjected to electrochemical dissolution, and convex structures 12 are gradually formed at positions corresponding to the cathode windows 10.

### Embodiment 3

The embodiment of the present disclosure further provides a system for counter-rotating electrochemical machining with internal flushing, including the cathode tool for counter-rotating electrochemical machining with internal flushing in Embodiment 1.

This embodiment further includes a power supply, a rotation driving apparatus for driving the cathode outer ring 2 and the anode workpiece 1 to rotate opposite to each other, an apparatus for providing an electrolyte, and the like.

There is a circular hole in a center of a fixed plate on a top of the cathode outer ring 2 shown in the drawings. The circular hole is used to be connected to a tail end of a drive shaft. The drive shaft drives the fixed plate to lead the cathode outer ring 2 to rotate. The drive shaft can close the circular hole. It may be understood that when other drive structures exist, for example, when a transmission structure is arranged on the top of the fixed plate to connect the drive shaft, the circular hole may be omitted, that is, a fixed plate without a hole is arranged to close an opening in the top of the cathode outer ring 2.

Specific examples are used for illustration of the principles and implementations of the present disclosure. The description of the above-mentioned embodiments is used to help illustrate the method and core principles of the present disclosure. In addition, those skilled in the art can make various modifications in terms of specific implementations and scope of application in accordance with the teachings of the present disclosure. In summary, the contents of this description should not be understood as the limitation of the present disclosure.

1. A cathode tool for counter-rotating electrochemical machining with internal flushing, comprising:
a cathode outer ring, wherein the cathode outer ring has an annular wall, the annular wall is a conductor, windows corresponding to convex structures on a surface of an anode workpiece are formed on an outer peripheral surface of the annular wall, and a liquid outlet structure is formed in an area corresponding to a non-convex region on the surface of the anode workpiece; and
a liquid supply assembly, wherein a liquid outlet of the liquid supply assembly is formed in the annular wall, the liquid outlet faces the anode workpiece, in a machining state, the cathode outer ring is able to rotate relative to the liquid outlet, the liquid outlet extends in a direction parallel to an axial direction of the annular wall, a bottom of the liquid outlet along the axial direction of the annular wall is not higher than a bottom of the liquid outlet structure along the axial direction of the annular wall, a top of the liquid outlet along the axial direction of the annular wall is not lower than a top of the liquid outlet structure along the axial direction of the annular wall, and the liquid supply assembly is configured to receive electrolyte from an outside and supply the electrolyte to the liquid outlet structure through the liquid outlet.

2. The cathode tool for counter-rotating electrochemical machining with internal flushing according to claim 1, wherein the liquid supply assembly comprises a cathode inner ring, the cathode inner ring is of a hollow sleeve-like structure, the cathode inner ring is arranged inside the cathode outer ring, the liquid outlet is formed in a side of the cathode inner ring, a liquid inlet is formed in a bottom or a top of the cathode inner ring, the cathode inner ring and the cathode outer ring are arranged coaxially, and the cathode outer ring is rotatably arranged relative to the cathode inner ring.

3. The cathode tool for counter-rotating electrochemical machining with internal flushing according to claim 2, further comprising a roller bracket, wherein the roller bracket is fixedly sleeved outside the annular wall, a plurality of circular arc grooves are formed in an outside of the roller bracket, the plurality of circular arc grooves are arranged parallel to an axis of the annular wall, sliding rollers are installed inside the plurality of circular arc grooves, and the cathode outer ring is sleeved outside the roller bracket and is in rolling contact with the sliding rollers.

4. The cathode tool for counter-rotating electrochemical machining with internal flushing according to claim 1, wherein the liquid outlet structure is narrow slits or a group of holes formed in the annular wall.

5. The cathode tool for counter-rotating electrochemical machining with internal flushing according to claim 3, wherein the cathode outer ring further comprises a fixed plate coaxially and fixedly arranged at an end of the annular wall; an end face of an end of the cathode inner ring is in sliding contact or clearance fit with an inner wall of the fixed plate; the cathode inner ring further comprises a first annular extension plate fixedly arranged at an end of the sleeve-like structure; and
the roller bracket is clamped and fastened on an outside of the cathode inner ring or is fixedly connected to the first annular extension plate through bolts.

6. The cathode tool for counter-rotating electrochemical machining with internal flushing according to claim 5, wherein a liquid inlet tube is fixedly connected to the bottom of the cathode inner ring, an end of the liquid inlet tube is configured with a second annular extension plate extending radially outward, the second annular extension plate is installed inside the annular wall, the second annular extension plate is fixedly connected to the cathode inner ring and/or the roller bracket, an annular pressure plate is arranged on an outside of the second annular extension plate, and the annular pressure plate is fixedly connected to an end face of the annular wall and axially limits the second annular extension plate.

7. The cathode tool for counter-rotating electrochemical machining with internal flushing according to claim 6, wherein annular sealing gaskets are clamped between the annular pressure plate and a side of the second annular extension plate, between an other side of the second annular extension plate and the end face of the cathode inner ring as well as an end face of the roller bracket, between a side of the first annular extension plate and an end face of the roller bracket, and between an other side of the first annular extension plate and the fixed plate.

8. The cathode tool for counter-rotating electrochemical machining with internal flushing according to claim 3, wherein a guiding groove is arranged on the roller bracket in an area corresponding to the liquid outlet, two of the circular arc grooves are arranged on two sides of the guiding groove, and electrolyte limit rollers are arranged in the two of the circular arc grooves on the two sides of the guiding groove.

9. A method for counter-rotating electrochemical machining with internal flushing, using the cathode tool for counter-rotating electrochemical machining with internal flushing according to claim 1 to perform electrochemical machining on the anode workpiece, wherein the method comprises:
during electrolysis, driving the anode workpiece and the cathode outer ring to rotate in opposite directions at a same angular speed around their own axes, and simultaneously, driving the cathode tool for counter-rotating electrochemical machining with internal flushing to step or move continuously toward the anode workpiece.

10. A system for counter-rotating electrochemical machining with internal flushing, comprising the cathode tool for counter-rotating electrochemical machining with internal flushing according to any one of claim 1.

11. The method for counter-rotating electrochemical machining with internal flushing according to claim 9, wherein the liquid supply assembly comprises a cathode inner ring, the cathode inner ring is of a hollow sleeve-like structure, the cathode inner ring is arranged inside the cathode outer ring, the liquid outlet is formed in a side of the cathode inner ring, a liquid inlet is formed in a bottom or a top of the cathode inner ring, the cathode inner ring and the cathode outer ring are arranged coaxially, and the cathode outer ring is rotatably arranged relative to the cathode inner ring.

12. The method for counter-rotating electrochemical machining with internal flushing according to claim 11, wherein the cathode tool further comprises a roller bracket, the roller bracket is fixedly sleeved outside the annular wall, a plurality of circular arc grooves are formed in an outside of the roller bracket, the plurality of circular arc grooves are arranged parallel to an axis of the annular wall, sliding rollers are installed inside the plurality of circular arc grooves, and the cathode outer ring is sleeved outside the roller bracket and is in rolling contact with the sliding rollers.

13. The method for counter-rotating electrochemical machining with internal flushing according to claim 9, wherein the liquid outlet structure is narrow slits or a group of holes formed in the annular wall.

14. The method for counter-rotating electrochemical machining with internal flushing according to claim 12, wherein the cathode outer ring further comprises a fixed plate coaxially and fixedly arranged at an end of the annular wall; an end face of an end of the cathode inner ring is in sliding contact or clearance fit with an inner wall of the fixed plate; the cathode inner ring further comprises a first annular extension plate fixedly arranged at an end of the sleeve-like structure; and
the roller bracket is clamped and fastened on an outside of the cathode inner ring or is fixedly connected to the first annular extension plate through bolts.

15. The method for counter-rotating electrochemical machining with internal flushing according to claim 14, wherein a liquid inlet tube is fixedly connected to the bottom of the cathode inner ring, an end of the liquid inlet tube is configured with a second annular extension plate extending radially outward, the second annular extension plate is installed inside the annular wall, the second annular extension plate is fixedly connected to the cathode inner ring and/or the roller bracket, an annular pressure plate is arranged on an outside of the second annular extension plate, and the annular pressure plate is fixedly connected to an end face of the annular wall and axially limits the second annular extension plate.

16. The method for counter-rotating electrochemical machining with internal flushing according to claim 15, wherein annular sealing gaskets are clamped between the annular pressure plate and a side of the second annular extension plate, between an other side of the second annular extension plate and the end face of the cathode inner ring as well as an end face of the roller bracket, between a side of the first annular extension plate and an end face of the roller bracket, and between an other side of the first annular extension plate and the fixed plate.

17. The method for counter-rotating electrochemical machining with internal flushing according to claim 12, wherein a guiding groove is arranged on the roller bracket in an area corresponding to the liquid outlet, two of the circular arc grooves are arranged on two sides of the guiding groove, and electrolyte limit rollers are arranged in the two of the circular arc grooves on the two sides of the guiding groove.

18. The system for counter-rotating electrochemical machining with internal flushing according to claim 10, wherein the liquid supply assembly comprises a cathode inner ring, the cathode inner ring is of a hollow sleeve-like structure, the cathode inner ring is arranged inside the cathode outer ring, the liquid outlet is formed in a side of the cathode inner ring, a liquid inlet is formed in a bottom or a top of the cathode inner ring, the cathode inner ring and the cathode outer ring are arranged coaxially, and the cathode outer ring is rotatably arranged relative to the cathode inner ring.

19. The system for counter-rotating electrochemical machining with internal flushing according to claim 18, further comprising a roller bracket, wherein the roller bracket is fixedly sleeved outside the annular wall, a plurality of circular arc grooves are formed in an outside of the roller bracket, the plurality of circular arc grooves are arranged parallel to an axis of the annular wall, sliding rollers are installed inside the plurality of circular arc grooves, and the cathode outer ring is sleeved outside the roller bracket and is in rolling contact with the sliding rollers.

20. The system for counter-rotating electrochemical machining with internal flushing according to claim 10, wherein the liquid outlet structure is narrow slits or a group of holes formed in the annular wall.
